(19) United States
(12) Patent Application Publication
(10) Pub. No.: US 2025/0291055 A1
(43) Pub. Date: Sep. 18, 2025

(54) UNMANNED AERIAL SYSTEMS AND METHODS FOR INTEGRATED ACTIVE RADAR AND PASSIVE RF SIGNAL SPECTRUM ANALYSIS

(71) Applicant: American Robotics Inc., Sparks, MD (US)

(72) Inventor: Timothy Tenne, Towson, MD (US)

(21) Appl. No.: 19/080,299

(22) Filed: Mar. 14, 2025

Related U.S. Application Data
(60) Provisional application No. 63/565,449, filed on Mar. 14, 2024.

(51) Int. Cl. G01S 13/933; G08G 5/72

(52) U.S. Cl. CPC G01S 13/933; G08G 5/72

(57) ABSTRACT

A system integrates active radar detection and passive RF signal spectrum analysis to produce an enhanced situational awareness dataset, enabling advanced transportation management and unmanned aerial systems (UAS) air traffic deconfliction. By correlating radar detections with ambient RF emissions, the system provides improved target identification, reduces false positives, and supports real-time autonomous decision-making for airspace safety and regulatory compliance.

### CROSS-REFERENCE TO RELATED APPLICATIONS

The present application claims the benefit of and priority to U.S. Provisional Patent Application No. 63/565,449, filed on Mar. 14, 2024, the entire contents of which is hereby incorporated by reference.

### TECHNICAL FIELD

The present disclosure relates to integrated transportation management systems, specifically focusing on the fusion of active radar, passive RF signal spectrum analysis, and software for managing and deconflicting unmanned aerial systems (UAS) air traffic.

### BACKGROUND

In the rapidly evolving landscape of transportation management and unmanned aerial systems (UAS), there is a growing demand for sophisticated solutions that can effectively manage and deconflict air traffic. Traditional systems often rely on isolated technologies to monitor air, ground, and maritime targets, which can lead to fragmented data and inefficiencies in traffic management. The lack of integration between these systems poses significant challenges in achieving a comprehensive and cohesive understanding of the operational environment.

### SUMMARY

The absence of an integrated, real-time platform for correlating active radar data with passive RF emissions limits accuracy, increases false positives, and hinders effective UAS management. Therefore, a comprehensive system providing fusion of active radar and passive RF spectrum data streams is needed to deliver real-time, unified situational awareness, enabling enhanced safety and autonomous decision-making for transportation management. The present disclosure introduces novel techniques and systems combining active radar detection with passive RF spectrum analysis, significantly improving integrated situational awareness for UAS traffic management and operational deconfliction.

In an aspect, the disclosure includes a system for fusing sensor data for integrated transportation management and unmanned aerial system (UAS) air traffic deconfliction, comprising one or more active radar panels configured to detect and track one or more targets; one or more passive radio frequency (RF) signal spectrum analyzers configured to acquire RF signals; a display configured to present an integrated situational awareness dataset for autonomously managing and deconflicting UAS air traffic; a processor; and a memory coupled to the processor and storing instructions which, when executed by the processor, cause the system to receive detection data from the one or more active radar panels; acquire RF signal data from the one or more passive RF signal spectrum analyzers; correlate the detection data and the RF signal data to extract target and signal information; fuse the extracted information to generate the integrated situational awareness dataset; and detect a target based on the integrated situational awareness dataset.

In another aspect, the disclosure includes a system wherein correlation of detection and RF data is performed through advanced tracking algorithms, such as Kalman filtering, providing predictive tracking capabilities, or multi-hypothesis tracking (MHT), enabling robust management of conflicting or ambiguous sensor inputs. These methods significantly enhance detection accuracy and reduce false positives in complex operational environments. The system may further perform pattern analysis and signal fingerprinting to classify unidentified radar returns that coincide with UAS frequency emissions; and classify the detected target based on the pattern analysis and signal fingerprinting. The system may also display the fused data on an integrated Geographic Information System (GIS)-based dashboard, providing a layered situational awareness view including at least one of a detected object, a trajectory of the detected object, RF activity of the detected object, or a conflict warning. The acquired RF signals may include at least one of: UAS radios, Automatic Dependent Surveillance-Broadcast (ADS-B), Automatic Identification System (AIS), or Remote ID. The one or more active radar panels may utilize phased array radar technology for target tracking and resolution. The one or more targets may include at least one of air, ground, or maritime targets, and the active radar panels may be configured to classify the one or more targets based on at least one of size, speed, or trajectory of the one or more targets. The display for integrated situational awareness may include a touch-screen interface for user interaction, and the display may utilize augmented reality (AR) to overlay situational data onto real-world views.

In another aspect, the disclosure includes a computer-implemented method for integrated transportation management and UAS air traffic deconfliction, comprising receiving detection data from one or more active radar panels; acquiring RF signal data from one or more RF signal spectrum analyzers; correlating the detection data and the RF signal data to extract target and signal information; fusing the extracted information to generate an integrated situational awareness dataset; and detecting a target based on the integrated situational awareness dataset. The method may include performing pattern analysis and signal fingerprinting to classify unidentified radar returns that coincide with UAS frequency emissions; and classifying the detected target based on the pattern analysis and signal fingerprinting. The method may further comprise displaying the fused data on an integrated GIS-based dashboard, providing a layered situational awareness view. The layered situational awareness view may include at least one of a detected object, a trajectory of the detected object, RF activity of the detected object, or a conflict warning. The acquired RF signals may include at least one of: UAS radios, ADS-B, AIS, or Remote ID. The one or more active radar panels may utilize phased array radar technology for target tracking and resolution. The one or more targets may include at least one of air, ground, or maritime targets, and the active radar panels may be configured to classify the one or more targets based on at least one of size, speed, or trajectory of the one or more targets.

In another aspect, the disclosure includes a non-transitory machine-readable storage medium in which is stored instructions for causing a processor to execute a computer-implemented method for integrated transportation management and UAS air traffic deconfliction, the method comprising receiving detection data from one or more active radar panels; acquiring RF signal data from one or more RF signal spectrum analyzers; correlating the detection data and the RF signal data to extract target and signal information; fusing the extracted information to generate an integrated situational awareness dataset; and detecting a target based on the integrated situational awareness dataset.

In another aspect, a system for integrated transportation management and unmanned aerial system (UAS) air traffic deconfliction, includes: one or more active radar panels configured to detect and track targets to provide high-resolution positional data; one or more passive radio frequency (RF) signal spectrum analyzers configured to acquire ambient RF signals for frequency analysis and classification; a display configured to visually present integrated, real-time, deconflicted situational awareness information for autonomous or human-assisted management of UAS air traffic; a processor; and a memory coupled to the processor and storing instructions which, when executed by the processor, cause the system to correlate and fuse active radar detection data and passive RF signal data to reduce false positives and enhance situational awareness.

Further details and aspects of exemplary aspects of the present disclosure are described in more detail below with reference to the appended figures.

### BRIEF DESCRIPTION OF THE DRAWINGS

A better understanding of the features and advantages of the disclosed technology will be obtained by reference to the following detailed description that sets forth illustrative aspects, in which the principles of the technology are utilized, and the accompanying drawings of which:

FIG. 1 is a system diagram illustration showing a system for fusing sensor data for integrated transportation management and unmanned aerial system (UAS) air traffic deconfliction, in accordance with aspects of the present disclosure;

FIG. 2 is a block diagram of a controller for the system of FIG. 1 in accordance with aspects of the present disclosure;

FIG. 3 is a side view of the system of FIG. 1, in accordance with aspects of the present disclosure;

FIG. 4 is a diagram illustrating a tripod of the system of FIG. 1, in accordance with aspects of the present disclosure;

FIG. 5 is a diagram illustrating a passive RF signal spectrum analyzer of the system of FIG. 1, in accordance with aspects of the present disclosure; and

FIG. 6 is a block diagram of the system of FIG. 1, in accordance with aspects of the present disclosure; and

FIG. 7 is a flow diagram illustrating a method for fusing sensor data for integrated transportation management and unmanned aerial system (UAS) air traffic deconfliction, in accordance with aspects of the present disclosure.

### DETAILED DESCRIPTION

For purposes of promoting an understanding of the principles of the present disclosure, reference will now be made to exemplary aspects illustrated in the drawings, and specific language will be used to describe the same. It will nevertheless be understood that no limitation of the scope of the present disclosure is thereby intended. Various alterations, rearrangements, substitutions, and modifications of the inventive features illustrated herein, and any additional applications of the principles of the present disclosure as illustrated herein, which would occur to one skilled in the relevant art and having possession of this disclosure, are to be considered within the scope of the present disclosure.

The disclosed technology involves the integration of active radar panels and a passive RF signal spectrum analyzer. The active radar panels detect and track air, ground, and maritime targets, providing high-resolution positional data. The passive RF signal spectrum analyzer captures RF signals from various sources, such as UAS radios and maritime signals, to identify radio frequency emissions. The system fuses the data by aggregating and analyzing these data streams, presenting them in a unified display for operators or autonomous systems. This integration enhances target classification, reduces false positives, and assigns confidence levels to detections. The system can be used for UAS air traffic management, autonomously deconflicting flight paths and ensuring safe operations. Additionally, the system can be embedded within autonomous UAS systems for dynamic adaptation to surroundings and regulatory compliance. The described technology aims to provide a comprehensive, real-time awareness solution across air, land, and maritime domains.

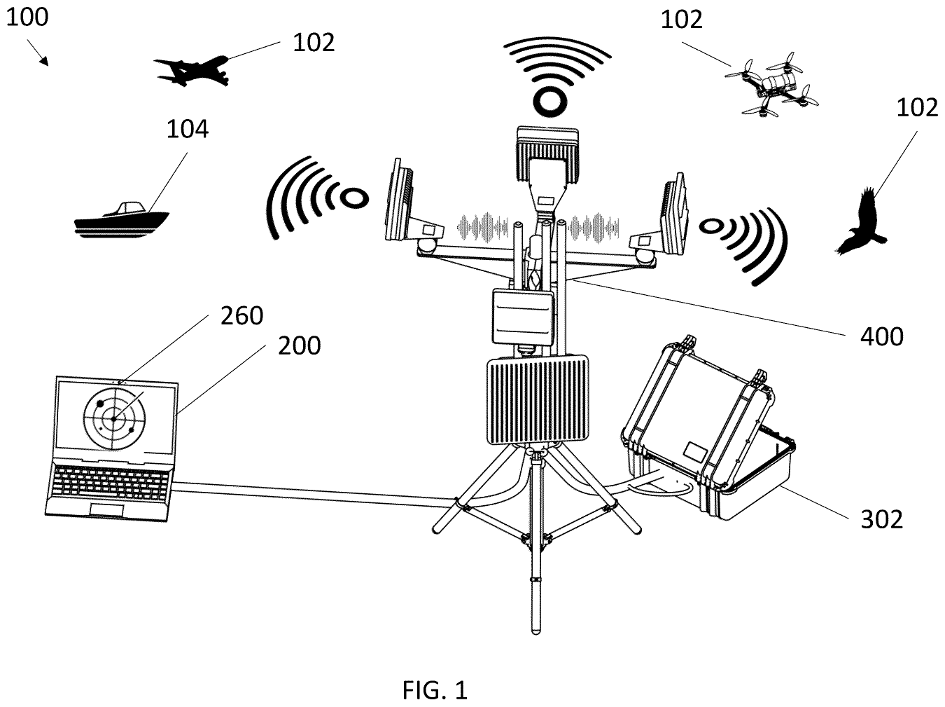

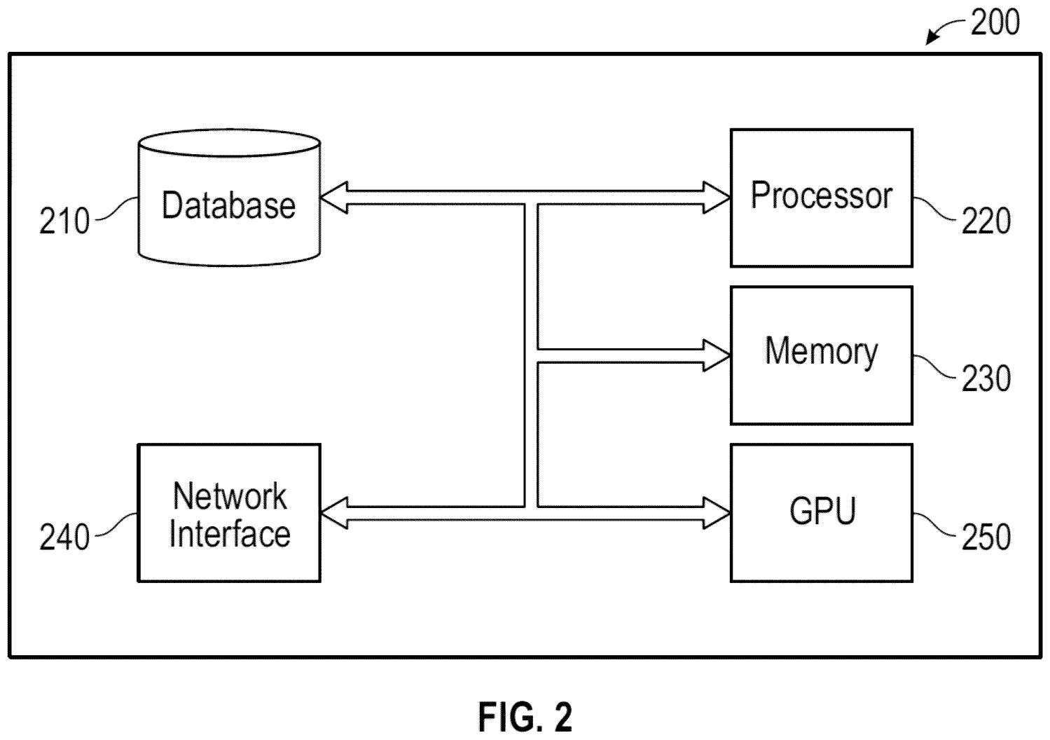

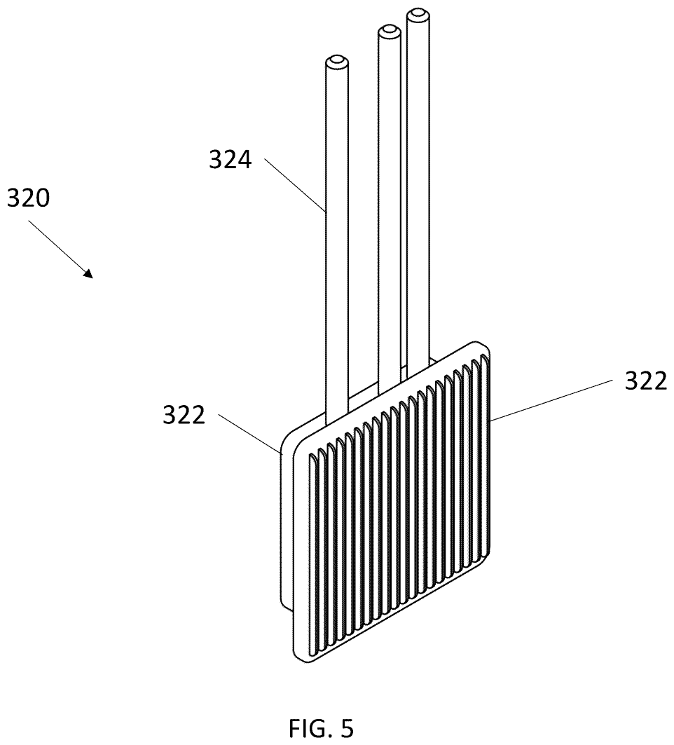

Referring to FIGS. 1 to 3, an exemplary system 100 for fusing sensor data for integrated transportation management and unmanned aerial system (UAS) air traffic deconfliction, in accordance with aspects of the disclosure, includes one or more active radar panels 310 configured to detect and track one or more targets 102, 104, one or more passive radio frequency (RF) signal spectrum analyzers 320 (FIG. 5), a display 260, and a controller 200 (FIG. 2). The one or more active radar panels 310 and the one or more passive radio frequency (RF) signal spectrum analyzers 320 are disposed on tripod 400

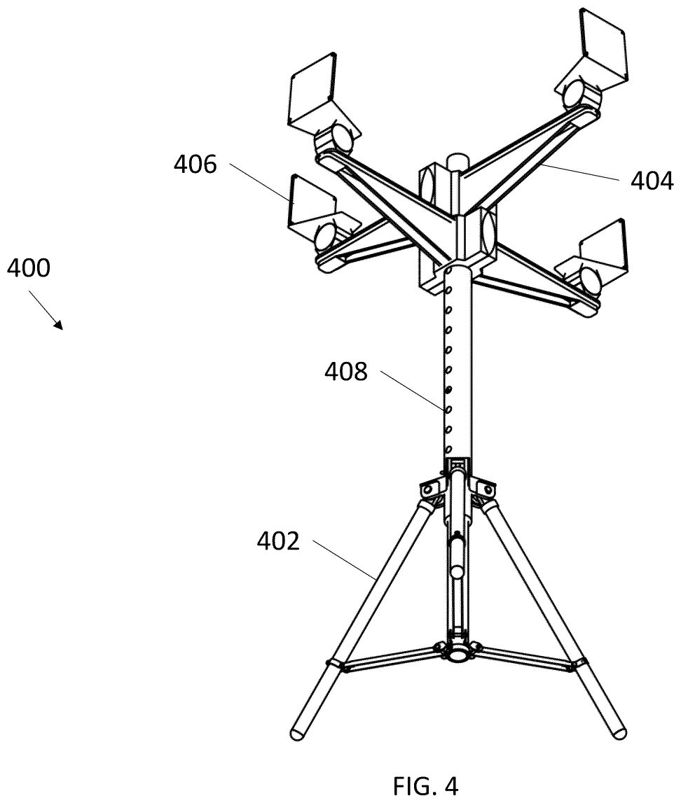

(FIG. 4). Controller 200 may be disposed on tripod 400 or may be remotely located. System 100 may include carrying case 302. Carrying case 302 may include a power source (e.g., a battery) for powering system 100. Carrying case 302 is configured to store and carry components of system 100. The co-location of the one or more active radar panels 310 and the one or more passive radio frequency (RF) signal spectrum analyzers 320 provides the benefit of enhanced situational awareness by allowing for real-time monitoring and analysis of both transmitted radar signals and received RF signals, improving the system's ability to detect, track, and identify targets while reducing interference and increasing overall detection accuracy.

Display 260 is configured to present an integrated situational awareness dataset for autonomously managing and deconflicting UAS air traffic. In aspects, display 260 (FIG. 1) may utilize augmented reality (AR) to overlay situational data onto real-world views. In aspects, display 260 (FIG. 1) may include a touch-screen interface for user interaction.

Referring now to FIG. 2, exemplary components in the controller 200 in accordance with aspects of the present disclosure include, for example, a database 210, one or more processors 220, at least one memory 230, and a network interface 240. In aspects, the controller 200 may include a graphical processing unit (GPU) 250, which may be used for processing machine learning models.

The database 210 can be located in storage. The term “storage” may refer to any device or material from which information may be capable of being accessed, reproduced, and/or held in an electromagnetic or optical form for access by a computer processor. Storage may be, for example, volatile memory such as RAM, non-volatile memory, which permanently holds digital data until purposely erased, such as flash memory, magnetic devices such as hard disk drives, and optical media such as a CD, DVD, Blu-ray disc, or the like.

As will be described in more detail later herein, the processor 220 executes various processes based on instructions that can be stored in the server memory 230 and utilizing the data from the database 210. With reference also to FIG. 1, a request from a patient device, such as a mobile device or a patient computer, can be communicated to the server through the server's network interface 240. The illustration of FIG. 2 is exemplary, and persons skilled in the art will be understood other components that may exist in a controller 200. Such other components are not illustrated in FIG. 2 for clarity of illustration.

Referring to FIG. 4, a tripod of system 100 of FIG. 1 is shown. Tripod 400 generally includes arms 404 supporting brackets 406 for mounting the one or more active radar panels 310. Tripod 400 includes three extendable legs 402, typically made of aluminum or other suitable material, which provide a sturdy base. Central portion 408 (i.e., center column) of tripod 400 may be height-adjustable, allowing users to fine-tune the elevation of any mounted devices (e.g., the one or more active radar panels 310 and/or passive RF signal spectrum analyzer 320). This column may be raised or lowered using a locking mechanism, such as a twist-lock or a geared crank system, to achieve the desired height. Tripod 400 provides the benefit of having adjustable features that enable use in uneven outdoor terrain to controlled indoor settings, offering both stability and flexibility in positioning.

Referring to FIG. 5, a passive RF signal spectrum analyzer 320 of the system of FIG. 1 is shown. Passive RF signal spectrum analyzers 320 are used to measure and analyze the frequency spectrum of RF signals without actively transmitting signals themselves. Passive RF signal spectrum analyzers 320 operate by detecting and processing electromagnetic signals present in the environment, providing insights into signal power, frequency content, and interference. Passive RF signal spectrum analyzer 320 generally includes one or more antennae 324 disposed on a housing 322 configured to house the spectrum analyzer electronics, and cooled by a heatsink. The one or more antennae 324 are configured to capture ambient RF signals, with different types used depending on the desired frequency range and sensitivity. The spectrum analyzer electronics generally included filters, a low-noise amplifier (LNA), a mixer and local oscillator (LO), and an analog-to-digital converter (ADC). The captured signal then passes through a preselector and bandpass filters, which help eliminate out-of-band interference and improve signal selectivity. A low-noise amplifier (LNA) boosts weak signals while minimizing additional noise, which is crucial for detecting low-power transmissions. Next, the signal is processed through a mixer and local oscillator (LO), where it is converted from its original high frequency to a lower intermediate frequency (IF) for easier analysis. The IF stage further amplifies and filters the signal to reduce distortion and enhance resolution. Once prepared, an analog-to-digital converter (ADC) digitizes the signal, making it suitable for processing by a digital signal processor (DSP) and Fast Fourier Transform (FFT) engine. These components perform real-time spectral analysis, identifying signal characteristics such as power, frequency, and/or modulation type.

The one or more passive radio frequency (RF) signal spectrum analyzers 320 are configured to acquire RF signals. The RF signals may include, for example, UAS radios, Automatic Dependent Surveillance-Broadcast (ADS-B), Automatic Identification System (AIS), or Remote ID. ADS-B is a surveillance technology used in aviation where aircraft broadcast their position, velocity, and other flight data via transponders. ADS-B allows air traffic control and other aircraft to track their movements in real time. AIS is a maritime tracking system that uses transponders on ships to broadcast their identity, position, speed, and course. Remote ID is used for vessel traffic management and collision avoidance at sea. Remote ID is a system mandated for Unmanned Aircraft Systems (UAS) that requires drones to broadcast identification and location information. Remote ID helps authorities and other airspace users identify and track drones operating in shared airspace, improving safety and regulatory compliance.

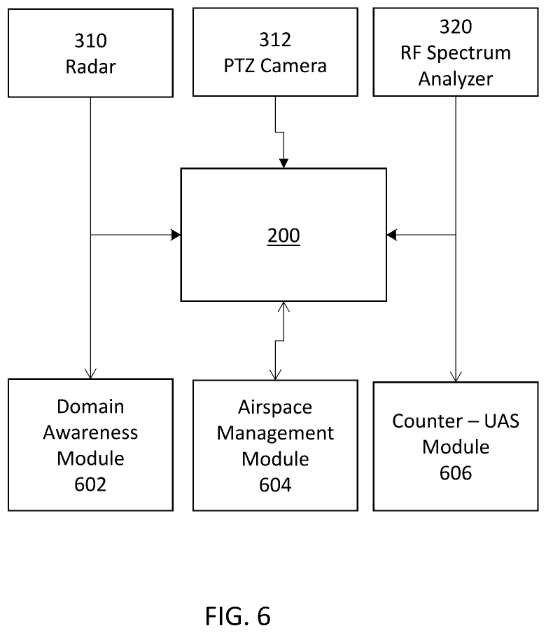

FIG. 6 shows a block diagram of the system 100 for fusing sensor data for integrated transportation management and unmanned aerial system (UAS) air traffic deconfliction of FIG. 1. Controller 200 is configured to ingest data from the passive RF signal spectrum analyzers 320, the PTZ camera 312, and/or the one or more active radar panels 310. System 100 may further include a domain awareness module 602, an airspace management module, and/or a counter UAS module 606.

The domain awareness module 602 is configured to process, integrate, and interpret data from the active radar panels and passive RF signal spectrum analyzer. Its primary function would be to enhance situational awareness by fusing positional tracking data from radar with RF signal emissions data, enabling more precise target classification and threat assessment. Domain awareness module 602 would aggregate multi-source data by collecting and synchronizing radar detections and RF signal analyses to create a comprehensive operational picture. Domain awareness module 602 may analyze and correlate information by cross-referencing radar-tracked objects with RF emissions to identify and classify targets, such as distinguishing between commercial and unauthorized UAS. Domain awareness module 602 reduces false positives by integrating multiple data sources to improve detection accuracy and assign confidence levels to targets. Domain awareness module 602 may further provide autonomous decision-making support by identifying potential conflicts, issuing alerts, and adjusting operations dynamically based on evolving threats. Domain awareness module 602 may enable support for applications such as UAS air traffic management, perimeter security, and/or maritime surveillance, ensuring real-time awareness and safer operational environments.

Airspace management module 604 is configured for organizing, monitoring, and/or regulating aerial operations to ensure safe and efficient use of airspace. By integrating data from the active radar panels 310 and passive RF signal spectrum analyzer 320, airspace management module 604 would track airborne objects, including UAS, manned aircraft, and potential aerial threats. Airspace management module 604 is configured to analyze flight paths, deconflict trajectories, and/or issue real-time alerts to prevent mid-air collisions or unauthorized incursions. Additionally, airspace management module 604 would assist in enforcing airspace regulations by identifying unauthorized UAS activity and coordinating appropriate responses, such as alerting authorities or autonomously redirecting compliant aircraft. Airspace management module 604 could also facilitate dynamic airspace adaptation by adjusting operational parameters based on environmental conditions, traffic density, or security threats.

Counter UAS (C-UAS) module 606 is configured to detect, track, classify, and/or mitigate unauthorized or potentially hostile unmanned aerial systems (UAS). By leveraging data from the active radar panels and passive RF signal spectrum analyzer, the module would identify unauthorized drones based on their radar signature, flight behavior, and RF emissions. C-UAS module 606 may analyze the threat level of each detected UAS, differentiating between benign commercial drones and potential security risks. C-UAS module 606 may then initiate countermeasures, such as electronic warfare techniques to disrupt communication links, GPS spoofing to misdirect hostile drones, or triggering alerts for security personnel to respond. In aspects, C-UAS module 606 may integrate with kinetic defense systems, such as net launchers or directed energy weapons, for high-threat scenarios.

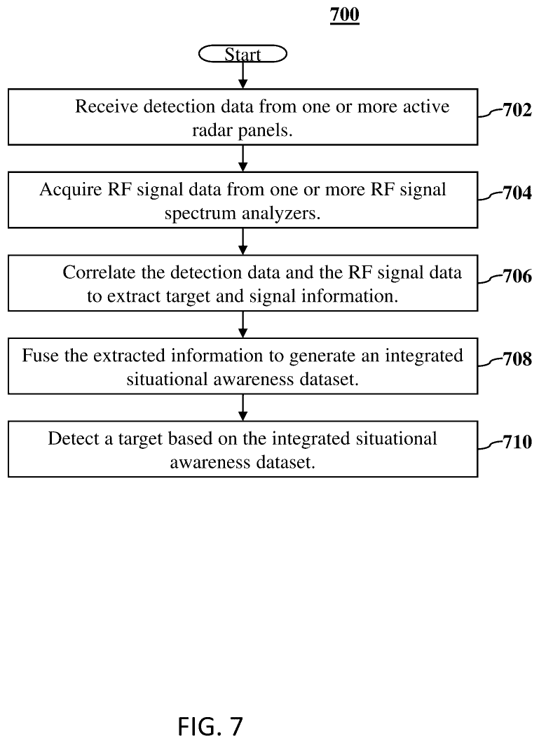

FIG. 7 shows a block diagram for fusing sensor data for integrated transportation management and unmanned aerial system (UAS) air traffic deconfliction. Although the steps of FIG. 7 are shown in a particular order, the steps need not all be performed in the specified order, and certain steps can be performed in another order. For example, FIG. 7 will be described below with a server (not shown) performing the operations. However, in various aspects, the operations of FIG. 7 may be performed all or in part by the controller 200 of FIG. 1. In aspects, the operations of FIG. 7 may be performed all or in part by another device, for example, a mobile device and/or a patient computer system. These and other variations are contemplated to be within the scope of the present disclosure.

System 100 of FIG. 1 provides the technical benefit of fusing the data and/or target to present an integrated transportation management system and/or network for managing and deconflicting UAS air traffic safety. It is contemplated that the features of system 100 can be integrated internally within UAS systems to create a fully autonomous solution.

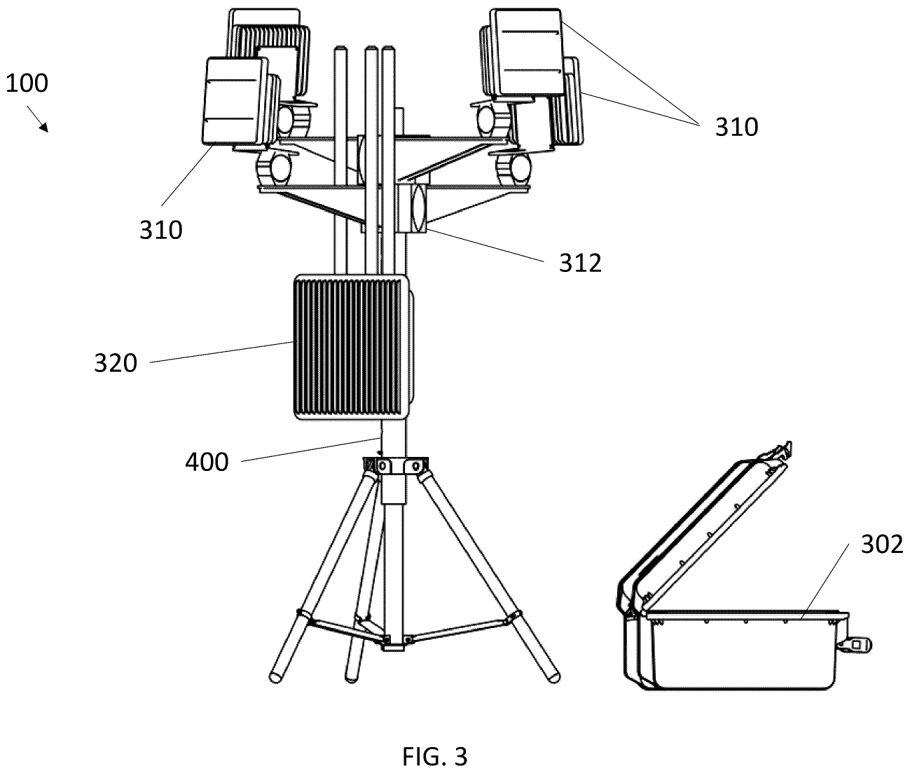

At operation 702, the controller 200 causes the system 100 to receive detection data from the one or more active radar panels 310 (FIG. 3).

At operation 704, the controller 200 causes the system 100 acquire RF signal data from the one or more passive RF signal spectrum analyzers 320 (FIG. 3).

In aspects, the controller 200 may cause the system 100 to acquire one or more images and/or video from a pan tilt zoom (PTZ) camera configured to provide high-resolution visual identification, allowing for automated tracking and verification of detected targets.

At operation 706, the controller 200 causes the system 100 correlate the detection data and the RF signal data to extract target and signal information. For example, data association algorithms such as Kalman filtering or multi-hypothesis tracking (MHT) may be used to correlate radar detections with RF-emitting entities. For example, if the one or more active radar panels 310 detect an airborne object at a specific range and bearing, and the one or more passive RF signal spectrum analyzers 320 simultaneously receives an ADS-B transmission at the same location, the system 100 can correlate these data points to verify the presence of a cooperative aircraft. For example, for non-cooperative UAS, the system 100 can use pattern analysis and signal fingerprinting to classify unidentified radar returns that coincide with common UAS frequency emissions. This fused data can then be displayed on an integrated GIS-based dashboard, providing operators with a layered situational awareness view, including detected objects, their trajectories, RF activity, and conflict warnings. Additionally, autonomous UAS platforms equipped with this system can ingest the fused dataset via onboard processors, allowing for real-time collision avoidance, adaptive rerouting, and compliance with airspace regulations.

In aspects, to fuse these data sources into a single operational display, the controller 200 may synchronize, and analyze the disparate data streams in real time. The active radar system will feed raw detection data, including range, bearing, velocity, and classification (air, ground, maritime) into the controller 200 using standardized interfaces such as ASTERIX for air surveillance or proprietary radar output formats. Simultaneously, the passive RF spectrum analyzer will scan for emissions within defined frequency bands (e.g., 900 MHZ, 2.4 GHz, 5 GHz for UAS control links; 1090 MHz for ADS-B; VHF for AIS signals), extracting key signal characteristics such as source ID, signal strength, modulation type, and potential geolocation through triangulation or received signal strength indicator (RSSI) analysis.

At operation 708, the controller 200 causes the system 100 to fuse the extracted information to generate the integrated situational awareness dataset.

At operation 710, the controller 200 causes the system 100 to detect a target 102 based on the integrated situational awareness dataset. In aspects, the controller 200 may cause the system 100 to classify the target 102 based on at least one of size, speed, or trajectory off the target. Target 102 may include, for example, air, ground, and/or maritime targets 104.

In aspects, the controller 200 may cause the system 100 to perform pattern analysis and signal fingerprinting to classify unidentified radar returns that coincide with UAS frequency emissions of the accessed RF signal data. In aspects, the controller 200 may cause the system 100 to classify the detected target based on the pattern analysis and signal fingerprinting.

In aspects, the controller 200 may cause the system 100 to display, on the display, the fused data on an integrated Geographic Information System (GIS)-based dashboard, providing a layered situational awareness view including at least one of a detected object, a trajectory of the detected object, RF activity of the detected object, or a conflict warning. A GIS-based (Geographic Information System) dashboard is a visual interface that integrates and displays spatial data on an interactive map, enabling real-time situational awareness and decision-making. GIS-based dashboard combines geographic information with operational data, allowing users to analyze and interact with live or historical data layers such as radar detections, RF signal sources, and/or vehicle or aircraft movements.

The GIS-based dashboard is configured to display detected air, ground, and maritime targets on a map, overlaying real-time RF emissions (e.g., ADS-B aircraft, AIS maritime vessels, UAS Remote ID signals) with radar-tracked objects. This enables users to see correlated data in a spatial format, identify potential conflicts, and/or manage traffic efficiently. In aspects, the GIS-based dashboard enables features including geofencing, trajectory prediction, and/or alerts for airspace violations, which provide the benefit of additional oversight.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different aspects in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms, or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages that are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached drawing figures are presented only to demonstrate certain examples of the disclosure. Other elements, steps, methods, and techniques that are insubstantially different from those described above are also intended to be within the scope of the disclosure.

What is claimed is:

1. A system for integrated transportation management and unmanned aerial system (UAS) air traffic deconfliction, the system comprising:
one or more active radar panels configured to detect and track one or more targets;
one or more passive radio frequency (RF) signal spectrum analyzers configured to acquire RF signals;
a display configured to present an integrated situational awareness dataset for autonomously managing and deconflicting UAS air traffic;
a processor; and
a memory coupled to the processor and storing instructions which, when executed by the processor, cause the system to:
receive detection data from the one or more active radar panels;
acquire RF signal data from the one or more passive RF signal spectrum analyzers;
correlate the detection data and the RF signal data to extract target and signal information;
fuse the extracted information to generate the integrated situational awareness dataset; and
detect a target based on the integrated situational awareness dataset.

2. The system of claim 1, wherein the correlation is performed using at least one of Kalman filtering or multi-hypothesis tracking (MHT).

3. The system of claim 1, wherein the instructions, when executed by the processor, further cause the system to:
perform pattern analysis and signal fingerprinting to classify unidentified radar returns that coincide with UAS frequency emissions of the accessed RF signal data; and
classify the detected target based on the pattern analysis and signal fingerprinting.

4. The system of claim 1, wherein the instructions, when executed by the processor, further cause the system to:
display, on the display, the fused data on an integrated Geographic Information System (GIS)-based dashboard, providing a layered situational awareness view including at least one of a detected object, a trajectory of the detected object, RF activity of the detected object, or a conflict warning.

5. The system of claim 1, wherein the acquired RF signals include at least one of: UAS radios, Automatic Dependent Surveillance-Broadcast (ADS-B), Automatic Identification System (AIS), or Remote ID.

6. The system of claim 1, wherein the one or more active radar panels utilize phased array radar technology for target tracking and resolution.

7. The system of claim 1, wherein the one or more targets include at least one of air, ground, or maritime targets.

8. The system of claim 7, wherein the instructions, when executed by the processor, further cause the system to:
classify the one or more targets based on at least one of size, speed, or trajectory of the one or more targets.

9. The system of claim 1, wherein the display for integrated situational awareness includes a touch-screen interface for user interaction.

10. The system of claim 6, wherein the display utilizes augmented reality (AR) to overlay situational data onto real-world views.

11. A computer-implemented method for integrated transportation management and unmanned aerial system (UAS) air traffic deconfliction, the method comprising:
receiving detection data from one or more active radar panels;
acquiring RF signal data from one or more RF signal spectrum analyzers;
correlating the detection data and the RF signal data to extract target and signal information;
fusing the extracted information to generate an integrated situational awareness dataset; and
detecting a target based on the integrated situational awareness dataset.

12. The method of claim 11, wherein the correlation is performed using at least one of Kalman filtering or multi-hypothesis tracking (MHT).

13. The method of claim 11, further comprising:
performing pattern analysis and signal fingerprinting to classify unidentified radar returns that coincide with UAS frequency emissions; and
classifying the detected target based on the pattern analysis and signal fingerprinting.

14. The method of claim 11, further comprising:
displaying the fused data on an integrated Geographic Information System (GIS)-based dashboard, providing a layered situational awareness view.

15. The method of claim 11, wherein the layered situational awareness view includes at least one of a detected object, a trajectory of the detected object, RF activity of the detected object, or a conflict warning.

16. The method of claim 11, wherein the acquired RF signals include at least one of: UAS radios, Automatic Dependent Surveillance-Broadcast (ADS-B), Automatic Identification System (AIS), or Remote ID.

17. The method of claim 11, wherein the one or more active radar panels utilize phased array radar technology for target tracking and resolution.

18. The method of claim 11, wherein the one or more targets include at least one of air, ground, or maritime targets.

19. The method of claim 18, wherein the active radar panels are configured to classify the one or more targets based on at least one of size, speed, or trajectory of the one or more targets.

20. A non-transitory machine-readable storage medium in which is stored instructions for causing a processor to execute a computer-implemented method for integrated transportation management and unmanned aerial system (UAS) air traffic deconfliction, the method comprising:
receiving detection data from one or more active radar panels;
acquiring RF signal data from one or more RF signal spectrum analyzers;
correlating the detection data and the RF signal data to extract target and signal information;
fusing the extracted information to generate an integrated situational awareness dataset; and
detecting a target based on the integrated situational awareness dataset.
